(19) United States
(12) Patent Application Publication
(10) Pub. No.: US 2013/0233575 A1
(43) Pub. Date: Sep. 12, 2013

(54) EMERGENCY RESPONSE SYSTEM

(71) Applicants: David L. McCoy, Medicine Park, OK (US); Daryl J. Howell, Tilden, TX (US); Michael W. McCoy, The Woodlands, TX (US)

(72) Inventors: David L. McCoy, Medicine Park, OK (US); Daryl J. Howell, Tilden, TX (US); Michael W. McCoy, The Woodlands, TX (US)

(21) Appl. No.: 13/415,929

(22) Filed: Mar. 9, 2012

(51) Int. Cl. A62C 27/00

(52) U.S. Cl. 169/24

(57) ABSTRACT

An emergency response system is provided. The emergency response system may include a mobile platform assembly having a fire suppression system and a medical care unit. The fire suppression system may suppress a fire by pumping a primary fire retardant material through a delivery hose and onto the fire. The medical care unit may include medical care supplies. The medical care unit may be sized and/or shaped, or otherwise configured to receive a patient and at least one medical care giver. The care giver may provide medical care to the patient while inside the medical care unit. The system may include a decontamination unit and a power source. The mobile platform may be a trailer or a vehicle.

### CROSS-REFERENCE TO RELATED APPLICATIONS

None.

### FIELD OF THE INVENTION

The present disclosure generally relates to an emergency response system, and more particularly, but not by limitation, to an emergency response system having a fire suppression system and a medical care unit.

### SUMMARY OF THE INVENTION

According to various embodiments, an emergency response system is provided. The emergency response system may include a mobile platform assembly having a fire suppression system and a medical care unit. The fire suppression system may suppress a fire by pumping a primary fire retardant material through a delivery hose and onto the fire. The medical care unit may include a wide variety of medical care supplies. The medical care unit may be sized and/or shaped, or otherwise configured to receive a patient and at least one medical care giver. The care giver may provide medical care to the patient while inside the medical care unit.

Other aspects may provide for the mobile platform to include a power source. The power source may be connected to and, thereby provide power to the fire suppression system and the medical care unit. The mobile platform may further comprise a chemical decontamination unit, e.g., an emergency eye-wash station and a shower assembly. The fire suppression system may further include a supply hose connectable to an external secondary fire retardant material. Some embodiments may provide for the fire suppression system combining the primary and secondary fire retardant materials and pump the combined materials through the delivery hose. Additionally, the fire suppression system may meter the amount of the primary fire retardant material that is combined with the secondary fire retardant material, or vice-versa. An exemplary primary fire retardant material is compressed air foam. In some embodiments, the mobile platform may be a trailer configured to be connected to a vehicle to be transferred between operation locations. Other embodiments may provide for the mobile platform assembly to be a vehicle which can be driven between operation locations.

According to some embodiments, an emergency response system is provided for responding to fire and/or medical emergencies at, for example, a remote location. The emergency response system may include a mobile platform assembly. The mobile platform assembly may include a fire suppression system and a medical care unit. The fire suppression system may include a supply tank storing a primary fire retardant material, a pump assembly, and a delivery hose. The fire suppression system may pump the primary fire retardant material through the delivery hose so as to be applied to a fire. The medical care unit may include medical care supplies and may also be sized and/or shaped to receive a patient and at least one medical care giver. The medical care giver may provide medical care to the patient while inside the medical care unit and using the medical care supplies. A vehicle may be connected to the mobile platform assembly so as to move the emergency response system between locations.

In some aspects, the fire suppression system may further include an instrument panel configured to permit a user to control the pumping of the primary fire retardant material. The fire suppression system may also include a power source connected to and supplying power to the pump assembly and/or the medical care unit. The medical care unit may further include a gurney. The emergency response system may also include a communications system configured to communicate with an external emergency response service. The user may utilize the communications system to coordinate additional emergency response actions.

According to even further embodiments, an emergency response system is provided that includes a mobile platform assembly. The mobile platform assembly may include a fire suppression system including a supply tank storing a compressed air foam, a pump assembly, and a delivery hose, the fire suppression system configured to pump the compressed air foam through the hose so as to be applied to a fire. The mobile platform assembly may also include a medical care unit including medical care supplies and configured to receive a patient and at least one medical care giver to permit the medical care giver to provide medical care to the patient. Other aspects may provide for the mobile platform assembly to include a chemical decontamination unit having, for example, an eye wash station and/or an emergency shower assembly. The mobile platform assembly may also include a power source.

### BRIEF DESCRIPTION OF THE DRAWINGS

FIG. 1 is a block diagram showing an exemplary emergency response system constructed in accordance with the present disclosure.

FIG. 2 is a perspective view of an alternate embodiment of an emergency response system constructed in accordance with the present disclosure.

FIG. 3 is a different perspective view of the alternate embodiment of the emergency response system shown in FIG. 2.

FIG. 4 is a different perspective view of the alternate embodiment of the emergency response system shown in FIG. 2.

FIG. 5 is a rear plan view of the alternate embodiment of the emergency response system shown in FIG. 2.

FIG. 6 is a side plan view of an emergency response system showing an embodiment wherein the mobile platform is a trailer.

FIG. 7 is a side plan view of an emergency response system showing an embodiment wherein the mobile platform is a vehicle.

### DETAILED DESCRIPTION OF THE INVENTION

Before explaining the presently disclosed and claimed inventive concept(s) in detail by way of exemplary embodiments, drawings, and appended claims, it is to be understood that the present disclosure is not limited in its application to the details of construction and the arrangement of the components set forth in the following description or illustrated in the drawings. The present disclosure is capable of other embodiments or of being practiced or carried out in various ways. As such, the language used herein is intended to be given the broadest possible scope and meaning; and the embodiments are meant to be exemplary—not exhaustive. It is to be understood that the phraseology and terminology employed herein is for the purpose of description and should not be regarded as limiting. Unless otherwise required by context, singular terms may include pluralities and plural terms may include the singular.

Generally, the present disclosure may provide for an emergency response system deployable to a remote site, e.g., an oil field site, to be used to provide on-site, immediate response to emergency situations. The emergency response system may enable immediate response to medical, fire, chemical, and/or explosion emergencies at remote locations. The emergency response system may be utilized to provide a safety net of initial measures to save lives and property until local support (e.g., additional emergency response services) arrives. Such immediate response capabilities may limit loss of time, production, and money. Additionally, reduction of long term effects of traumatic injuries sustained on the job site may be achieved utilizing the presently described and claimed emergency response system.

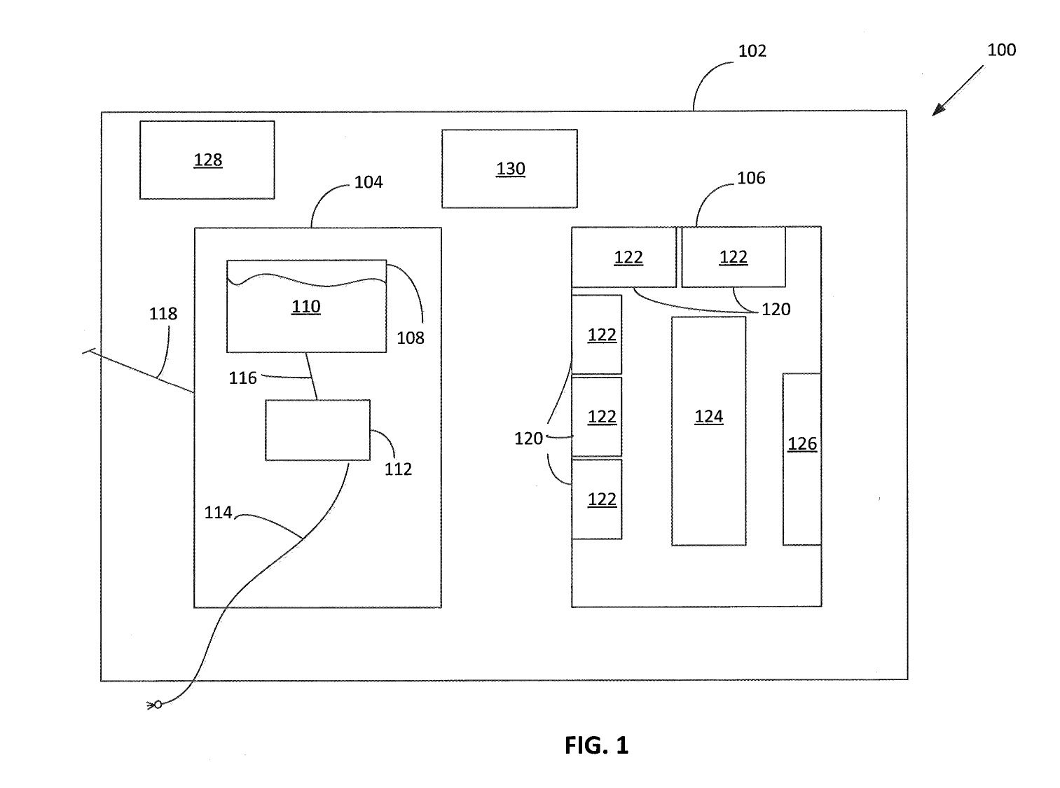

Referring to the drawings, and in particular to FIG. 1, shown therein is a block diagram of an exemplary emergency response system 100 constructed in accordance with the present disclosure. The system 100 may comprise a mobile platform 102, the mobile platform 102 including a fire suppression system 104 and a medical care unit 106. Generally, the mobile platform 102 may be sized, shaped, or otherwise configured to mount or connect the fire suppression system 104 and the medical care unit 106 thereon. The mobile platform 102 may be constructed of a rugged material, e.g., steel, so as to support the weight of the equipment mounted or connected thereon as well as to endure the challenging operating conditions during use. The mobile platform 102 may be embodied as a trailer (e.g., a bumper pull, gooseneck, or fifth-wheel trailer) that is connectable to a vehicle in order to be moved between operational locations. Alternatively, the mobile platform 102 may be embodied as a vehicle (e.g., an extended bed truck or pick-up) wherein the fire suppression system 104 and the medical care unit 106 may be mounted thereon.

The fire suppression system 104 and the medical care unit 106 may be securely mounted or otherwise connected to the mobile platform 102. The fire suppression system 104 and the medical care unit 106 may be permanently mounted on the mobile platform 102, e.g., during manufacture of the emergency response system 100. The fire suppression system 104 and the medical care unit 106 may be connected to the mobile platform 102 by, for example, welding, hardened steel bolts (e.g., grade 5 or 8 bolts), other fastening mechanisms, or combinations thereof. Other embodiments may provide for the fire suppression system 104 and the medical care unit 106 to be connected to otherwise mounted to the mobile platform 102 so as to be removable. Such configuration may provide for exchanging the fire suppression system 104 and/or the medical care unit 106 to accommodate specific operational requirements.

Generally, the fire suppression system 104 may suppress a fire by pumping a fire retardant material through a hose and onto the fire. The fire suppression system 104 may be configured or otherwise pump the fire retardant material onto the fire from a safe distance away so as to prevent or minimize injuries to the user. In a preferred embodiment, the fire suppression system 104 may be used by an emergency responder to pump a fire retardant material (e.g., foam/water) at a rate of 200-250 gallons-per-minute on a fire from 125-150 feet away. In an exemplary embodiment, the fire suppression system 104 may include a supply tank 108 storing a primary fire retardant material 110, a pump assembly 112, and a delivery hose 114. The pump assembly 112 may be in fluid communication with the supply tank 108 via, for example, one or more inter-connecting hoses 116, and the delivery hose 114 so as to pump the material 110 from the supply tank 108 and through the hose 114 to be dispersed onto the fire. The pump assembly 112 may be sized or otherwise configured to provide predetermined pressure and/or flow rate on the fire retardant material 110 being pumped through the hose 114 in order to project the material 110 a safe distance. That is, the pump assembly 112 may provide sufficient pressure and/or flow rate to the material 110 leaving the hose 114 so that the user can maintain a safe distance from the fire during operation. In some embodiments, the fire suppression system 104 may include an instrument panel (not shown in FIG. 1) wherein a user can control and monitor the functions of the fire suppression system 104. The instrument panel may include one or more switches, actuators, adjustment knobs, gauges, connectors, and the like, wherein a user can access, monitor, and/or control the functions of the fire suppression system 104. The instrument panel may further provide controls and the like wherein the user can adjust the parameters of the fire suppression system 104 (e.g., adjust the pressure of the pump assembly 112). Furthermore, the instrument panel may include a plurality of gauges informing the user of the operational states of the components included in the fire suppression system 104 (e.g., the pressure, volume, flow rate, etc.). Lastly, the instrument panel may also include one or more outlet ports wherein an emergency responder may connect additional hoses such that more than one responder can use the fire suppressions system 104 to fight the fire.

Other aspects may also provide for the fire suppression system 104 to include a supply hose 118 that may be connectable to an external secondary fire retardant material (not shown). The secondary fire retardant material may be provided by, for example, a secondary storage tank, a fire hydrant, or combinations thereof. The fire suppression system 104 may further include hoses, valves, regulators, gauges, and the like which permit combining the primary and the secondary fire retardant materials during use. That is, connecting the supply hose 118 to the secondary fire retardant material may permit the pump assembly 112 and/or other components (e.g., valves, gauges, etc.) of the fire suppression system 104 to mix, in a controlled or metered manner, the two materials. The fire suppression system 104 may include controls (e.g., valves, electronic switches, etc.) and the like which permit the user to control the mixture rate of the primary and secondary fire retardant materials. In some embodiments, the user may utilize the instrument panel to control such mixtures and mixture rates. The responder may use the instrument panel to control the mixture rate dynamically or on an as needed basis, i.e., as the fire evolves or in response to specific fire parameters. In one example, the primary fire retardant material 110 is a foam based material and the secondary retardant material is water, wherein the combination of the primary and secondary materials is applied to the fire. Other exemplary fire retardant materials include, but are not limited to, water, class A foam, class B foam (e.g., synthetic foams, aqueous film forming foams (AFFF), alcohol-resistant AFFF, protein foams, and the like), and/or combinations thereof.

Other aspects may provide for the fire suppression system 104 to include a plurality of spare hoses. The user may connect the spare hoses to, for example, the delivery hose 114 so as to extend the length thereof. The spare hoses may also be connected to the supply hose so as to reach remotely located secondary fire retardant material.

Referring still to FIG. 1, the medical care unit 106 may include medical care supplies and may also be sized and/or shaped, or otherwise configured to receive a patient and at least one medical care giver to permit the medical care giver to provide medical care to the patient inside of the medical care unit 106. Some embodiments may provide for the medical care unit 106 to include, for example, a plurality of storage cabinets 120 storing medical care supplies 122, a gurney 124, and one or more workbenches 126. The medical supplies 122 stored in the medical care unit 106 may change from mission to mission so as to adapt to specific requirements. Exemplary medical supplies 122 stored in the medical care unit 106 may include, but are not limited to, ventilation and airway equipment, vascular access equipment, cardiac monitoring and defibrillation equipment, medications, respirator, immobilization devices, bandages, and combinations thereof. The gurney 124 may be sized and/or configured so as to permit a medical care provider to load the patient thereon at the injury site and transport the patient back to the medical care unit 106. The medical care provider may load the gurney 124 into the medical care unit 106 and proceed to provide medical care to the patient from, for example, the workbench 126.

Various embodiments may also provide for the system 100 to include a chemical decontamination unit 128. The chemical decontamination unit 128 may be a personal decontamination unit including components or being otherwise configured to decontaminate an individual. The decontamination unit 128 may be used to remove unwanted chemicals from an individual, i.e., to mitigate the damage caused by an accidental chemical spill. Exemplary components forming the chemical decontamination unit 128 may include, but are not limited to, an emergency eye-wash station and an emergency shower station. An individual can use the eye-wash station and/or the shower station to flush an exposed area with, for example, copious amounts of water, in order to remove the unwanted chemical.

Other embodiments may also provide for the system 100 to include a power source 130. The power source 130 may be connected to the fire suppression system 104 and/or the medical care unit 106 so as to provide power thereto. An exemplary power source 130 may be a generator. The power source 130 may be securely mounted to the mobile platform 102. Alternatively, the power source 130 may be removably associated with the system 100 so as to facilitate positioning the generator a short distance therefrom to, for example, minimize noise and/or safety hazards associated with generator use. In an even further embodiment, the system 100 may include wiring, connections, and the like, permitting connection of the system 100 to a local power source (i.e., a power source separate from the system 100). The power source 130 may provide power to the pump 112 to pump the primary and/or secondary fire retardant material onto the fire.

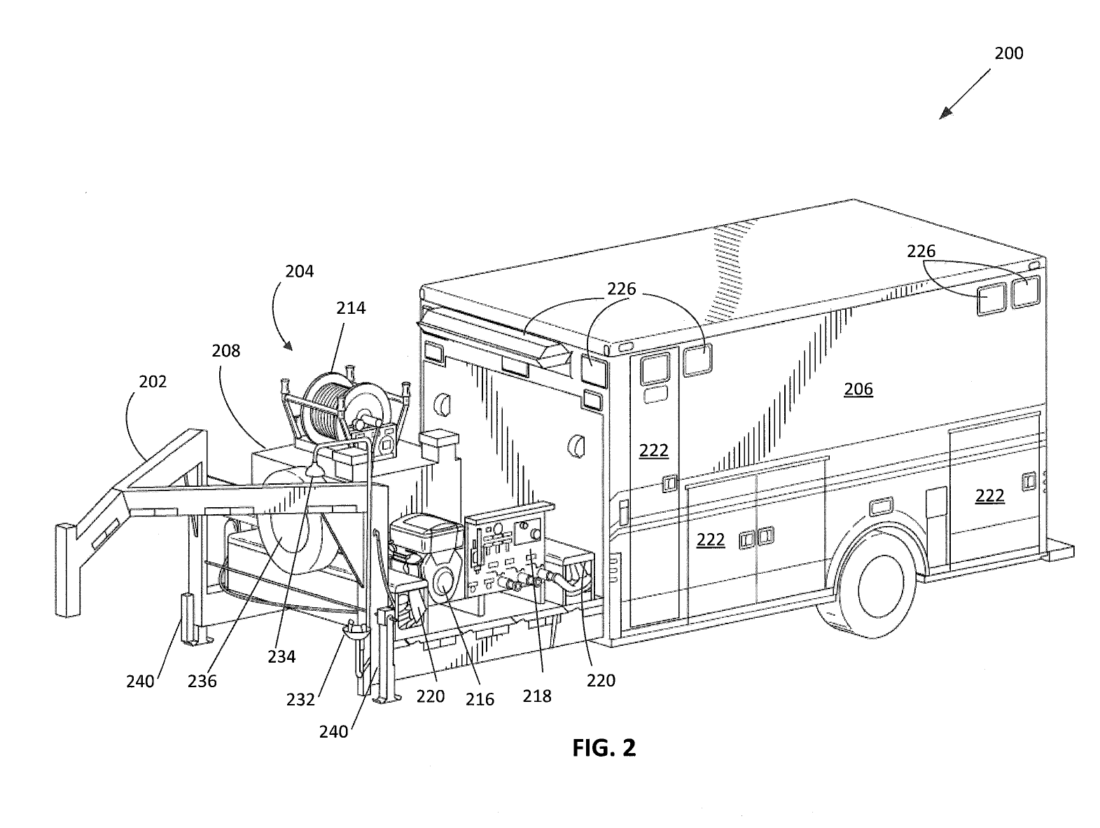

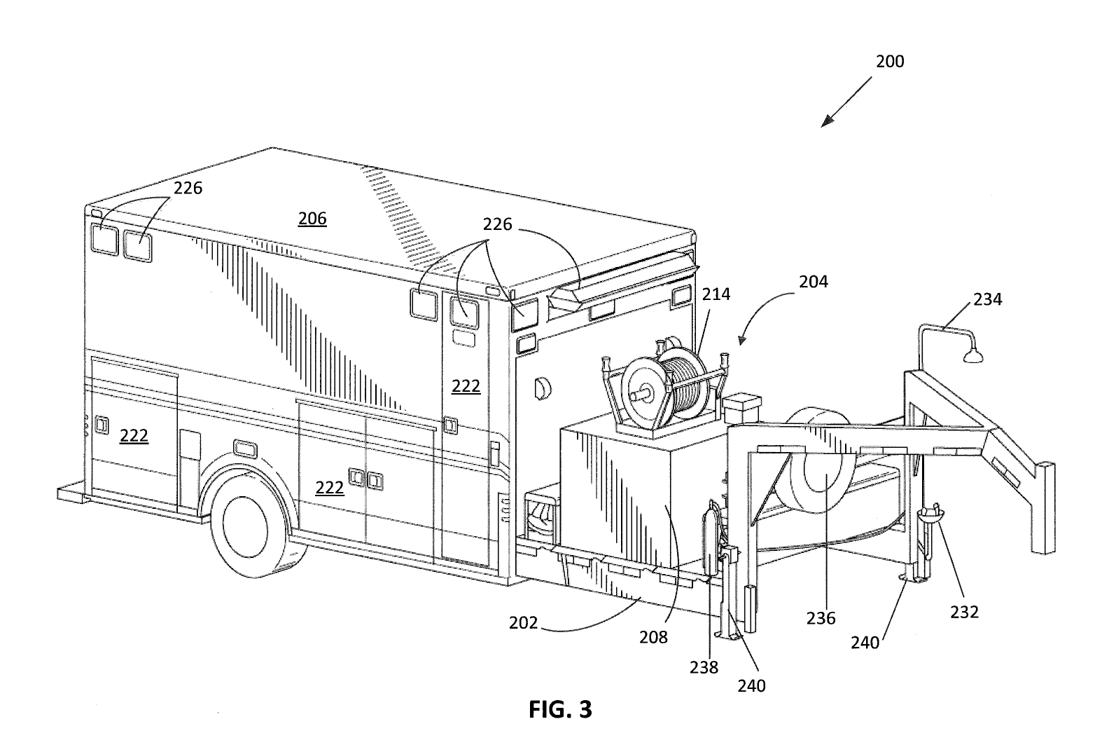

Referring now to FIGS. 2-5, shown therein are differing perspective views of an alternate embodiment of an emergency response system 200 constructed in accordance with the present disclosure. The system 200 comprises a mobile platform assembly 202 including a fire suppression system 204 and a medical care unit 206. The mobile platform assembly 202 is embodied as a trailer, more particularly a gooseneck trailer. The trailer can be connected to a vehicle in order to move the system 200 between operational locations. The fire suppression unit 204 includes a supply tank 208 holding a fire retardant material, a pump assembly, and one or more hoses 214. The pump assembly is in fluid communication with the supply tank 208 in order to pump the fire retardant material onto the fire through the delivery hoses 214. The fire suppression system 204 further includes a power source 216 and an instrument control panel 218. The instrument panel 218 includes valves, switches, gauges, connections, and the like, to permit a user to control and/or monitor the operational state of the fire suppression system 204.

The fire suppression system 204 may also include a plurality of spare hoses 220 (two being shown in FIGS. 2-5 by way of example). The spare hoses 220 can be connected to the delivery hose 214 so as to extend the length thereof. Other aspects may provide for the instrument panel 218 to include a plurality of outlet ports wherein the spare hoses 220 can be connected thereto so as to provide additional sources of fire retardant material onto the fire. The instrument panel 218 may include an illumination source permitting continued use of the fire suppression system in low-light conditions.

The medical care unit 206 is positioned on, or otherwise connected to the mobile platform assembly 202. Generally, the medical care unit 206 includes medical care supplies and is configured (i.e., sized and/or shaped) to receive a patient and at least one medical care giver. The medical care giver may provide medical care to the patient inside the medical care unit 206. In the embodiment shown in FIGS. 2-5, the medical care unit 206 is similar to an ambulance box. It should be understood though that the medical care unit 206 is not limited in its implementation to be similar to an ambulance box. Other configurations and/or designs are also considered within the scope of the present disclosure. For instance, custom sized and/or shaped structures may be used to form the medical care unit 206.

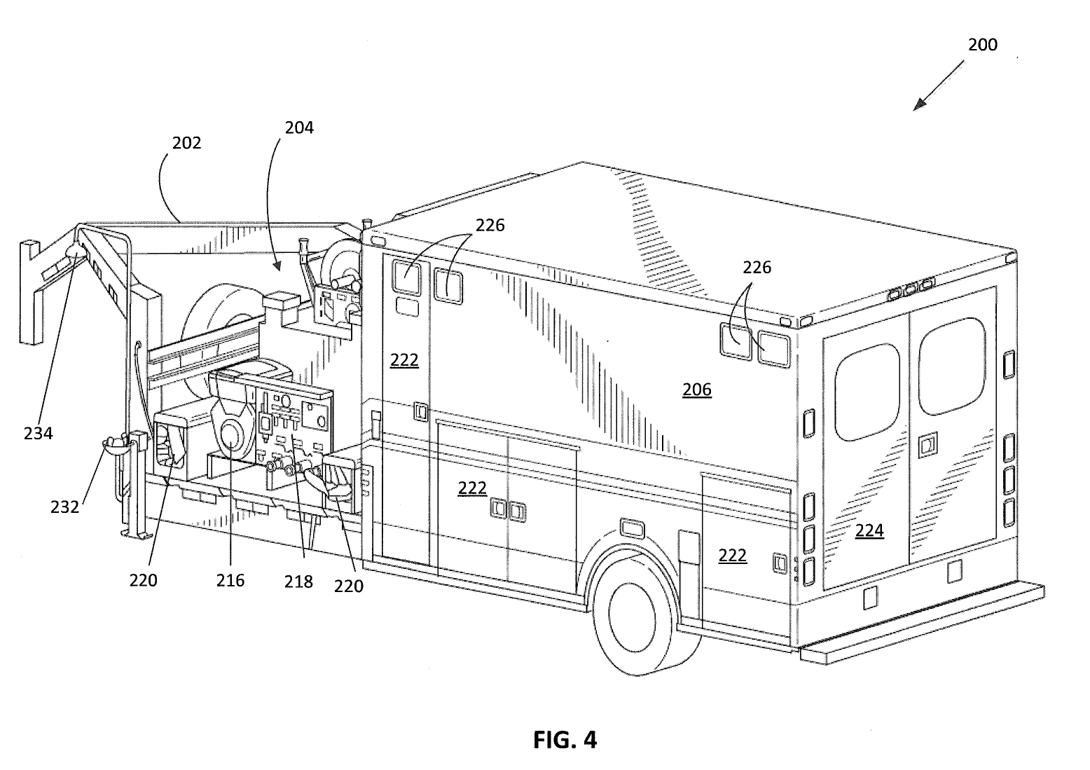

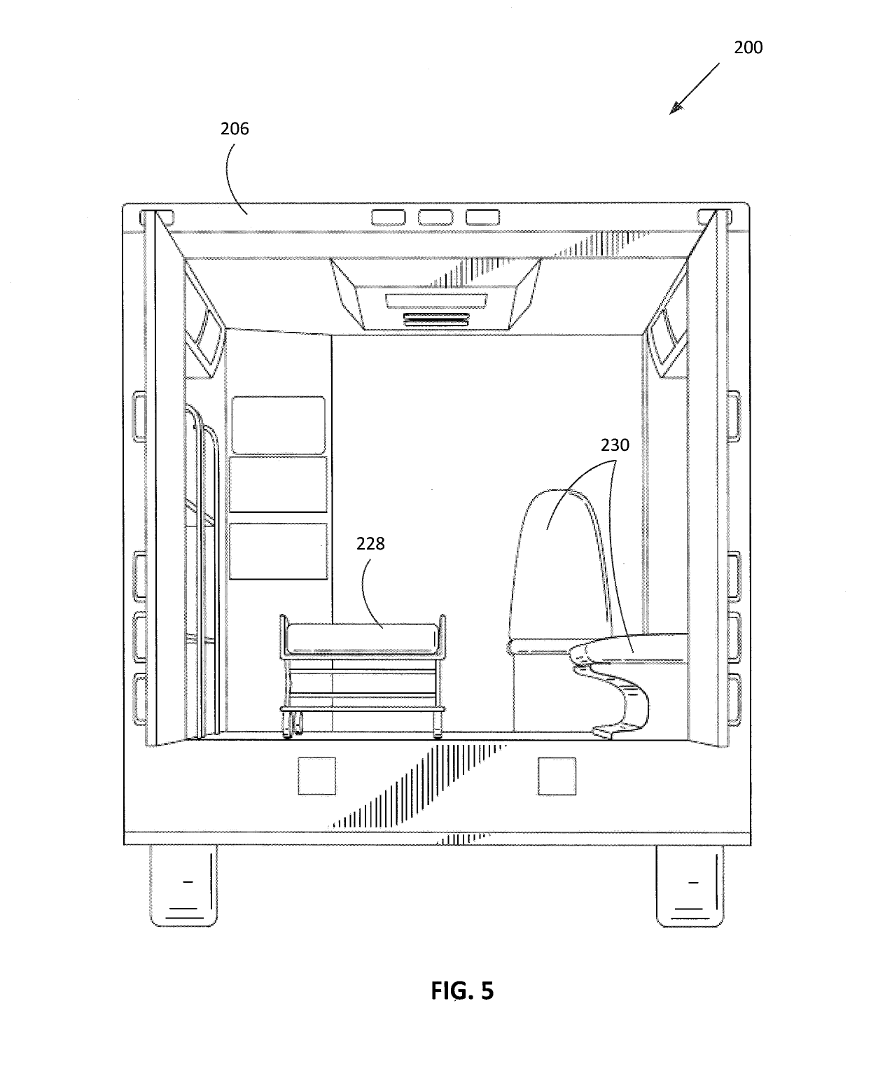

The medical care unit 206 includes storage cabinets 222 storing the medical care supplies. As shown, the storage cabinets 222 may include doors securing the medical care supplies inside when not in use. The medical care unit 206 may further include one or more doors 224 (see FIGS. 4-5) providing ingress and egress points to the medical care unit 206. In some embodiments, the medical care unit 206 may include a plurality of external lights 226 providing illumination to the surrounding area. The medical care unit 206 may include a gurney 228 and one or more workbenches 230. The user may load a patient on the gurney 228 through the doors 224 into the medical care unit 206 so as to provide medical care therein.

The system 200 further includes a personal decontamination unit comprised of an emergency eye wash station 232 and a shower station 234. The decontamination unit generally provides for removal of an unwanted chemical, debris, etc., from an individual. For example, the eye wash station 232 may be used to flush the individual's eyes out with water to remove contaminants or foreign debris. Also, the shower station 234 may be used to rinse an individual with water or other chemicals to remove any unwanted contaminants or debris. In one embodiment, the personal decontamination unit may be in fluid communication with the supply tank 208 or an external source so as to provide the removal substance to the person. Other embodiments may provide for the personal decontamination unit to include a source of chemical removal substance, e.g., stored in a separate storage tank. In a preferred embodiment, the chemical removal substance is water and may be stored in a sterile manner.

The system 200 may even further include a spare tire 236, a spare fire extinguisher 238 and one or more leveling jacks 240. The leveling jacks 240 may be used to secure and level the mobile platform assembly 202 after being positioned at the operational location.

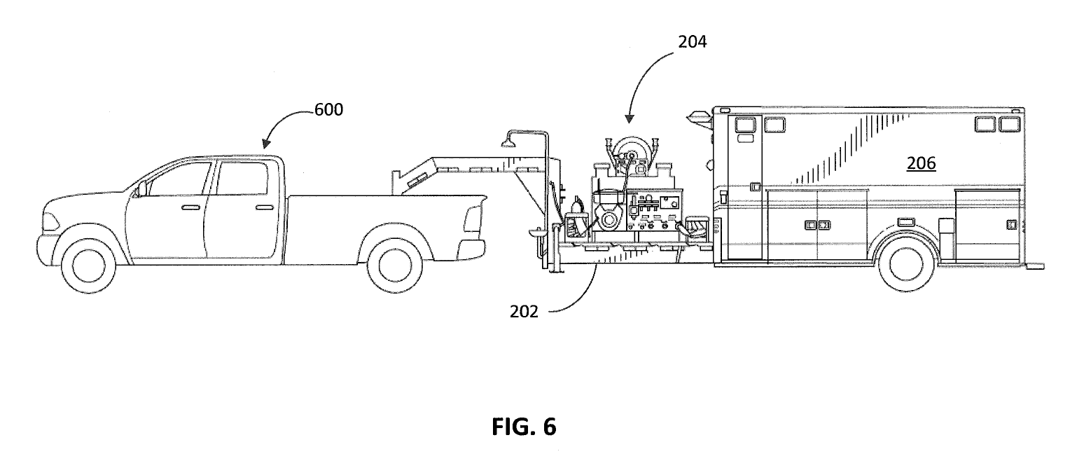

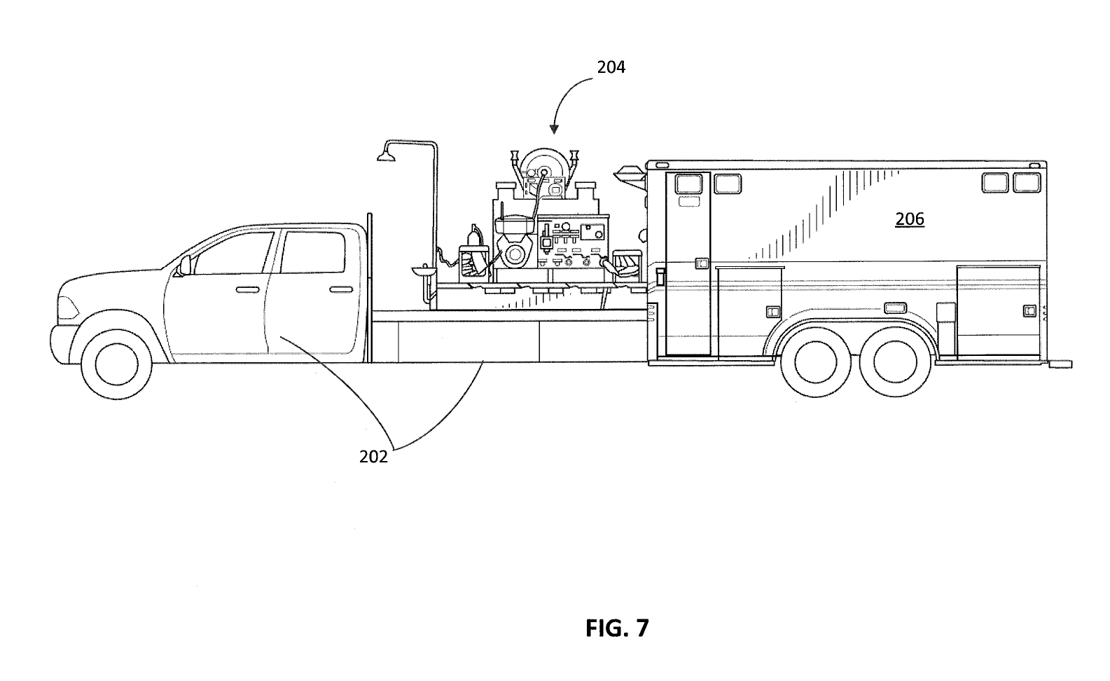

Turning now to FIGS. 6 and 7, shown therein are side views showing different embodiments of the mobile platform assembly 202 constructed in accordance with the present disclosure. As discussed above, the mobile platform assembly 202 can be embodied as a trailer or as a vehicle. FIG. 6 shows the embodiment wherein the mobile platform assembly 202 is embodied as a trailer, more particularly a goose-neck trailer. The trailer embodiment of the mobile platform assembly 202 can be connected to a vehicle 600 in order to be transported between operation locations. The embodiment shown in FIG. 6 is similar to the embodiments shown in FIGS. 2-5, wherein the mobile platform assembly 202 includes the fire suppression system 204 and the medical care unit 206.

FIG. 7 shows an alternate embodiment of an emergency response system wherein the mobile platform assembly 202 is embodied as a vehicle. More particularly, the mobile platform assembly 202 is embodied as an extended bed truck or pick-up wherein the fire suppression system 204 and the medical care unit 206 are mounted on the bed of the vehicle. As would be understood, the vehicle would be used to transport the emergency response system between operation locations.

In accordance with additional aspects of the present disclosure, the responders positioned with and operating the emergency response system 100 or 200 may generally be trained, certified, and/or experienced in both firefighting techniques and also medical care. Such cross-trained responders may utilize the herein disclosed emergency response system 100 or 200 to provide emergency response services. For additional information, see Applicants' co-pending patent application entitled “Methods for Improving Safety Conditions and Mitigating Emergencies at a Work Site,” identified by application Ser. No. ______, filed Mar. 9, 2012, the contents of which are incorporated herein by reference in its entirety.

While the present invention has been described in connection with a series of preferred embodiments, these descriptions are not intended to limit the scope of the invention to the particular forms set forth herein. The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. The present descriptions are intended to cover such alternatives, modifications, and equivalents as may be included within the spirit and scope of the invention as defined by the appended claims and otherwise appreciated by one of ordinary skill in the art. In several respects, embodiments of the present invention may act to close the loopholes in the current industry practices in which good business practices and logic are lacking because it is not feasible to implement with current resources and tools.

What is claimed is:

1. An emergency response system comprising:
a mobile platform assembly comprising;
a fire suppression system suppressing a fire by pumping a primary fire retardant material through a delivery hose and onto the fire; and
a medical care unit including medical care supplies and configured to receive a patient and at least one medical care giver to permit the medical care giver to provide medical care to the patient.

2. The system of claim 1, wherein the mobile platform further comprises a power source connected to, and providing power to the fire suppression system and the medical care unit.

3. The system of claim 1, wherein the mobile platform further comprises a chemical decontamination unit.

4. The system of claim 3, wherein the chemical decontamination unit includes one or more of an emergency eye-wash station or a shower assembly.

5. The system of claim 1, wherein the fire suppression system further comprises a supply hose configured to connect to an external secondary fire retardant material.

6. The system of claim 5, wherein the fire suppression system is configured to combine the primary and secondary fire retardant materials and pump the combined materials through the delivery hose.

7. The system of claim 6, wherein the fire suppression system is configured to meter the amount of primary fire retardant material that is combined with the secondary fire retardant material.

8. The system of claim 1, wherein the primary fire retardant material is compressed air foam.

9. The system of claim 1, wherein the mobile platform is a trailer configured to be connected to a vehicle.

10. The system of claim 1, wherein the mobile platform is a vehicle.

11. An emergency response system comprising:
a mobile platform assembly comprising;
a fire suppression system including a supply tank storing a primary fire retardant material, a pump assembly, and a delivery hose, the fire suppression system configured to pump the primary fire retardant material through the delivery hose so as to be applied to a fire; and
a medical care unit including medical care supplies and configured to receive a patient and at least one medical care giver to permit the medical care giver to provide medical care to the patient.

12. The system of claim 11, further comprising a vehicle connected to the mobile platform assembly so as to move the emergency response system between operating locations.

13. The system of claim 11, wherein the fire suppression system further comprises an instrument panel configured to permit a user to control the pumping of the fire retardant material.

14. The system of claim 11, wherein the fire suppression system further comprises a power source connected to and supplying power to the pump assembly.

15. The system of claim 11, wherein the medical care unit further includes a gurney.

16. The system of claim 11, further comprising a communications system configured to communicate with an external emergency response service.

17. An emergency response system comprising:
a mobile platform assembly comprising;
a fire suppression system including a supply tank storing a compressed air foam, a pump assembly, and a delivery hose, the fire suppression system configured to pump the compressed air foam through the delivery hose so as to be applied to a fire;
a medical care unit including medical care supplies and configured to receive a patient and at least one medical care giver to permit the medical care giver to provide medical care to the patient; and
a chemical decontamination unit.

18. The system of claim 17, wherein chemical decontamination unit further comprises an eye wash station.

19. The system of claim 17, wherein the chemical decontamination unit further comprises an emergency shower station.

20. The system of claim 17, wherein the mobile platform further comprises a power source.
